(19) United States
(12) Patent Application Publication
(10) Pub. No.: US 2018/0314998 A1
(43) Pub. Date: Nov. 1, 2018

(54) Resource Allocation in a Network System

(71) Applicant: Uber Technologies, Inc., San Francisco, CA (US)

(72) Inventor: Yifang Liu, Burlingame, CA (US)

(21) Appl. No.: 15/498,174

(22) Filed: Apr. 26, 2017

(51) Int. Cl. G06Q 10/06; G06Q 50/30; G06Q 10/04

(52) U.S. Cl. CPC G06Q 10/06313; G06Q 50/30; G06F 17/30241; G06Q 10/04; G06Q 10/067

(57) ABSTRACT

A network system, such as a transportation management system, efficiently allocates providers among different geographic regions by providing multiple service options to users. A trip management module detects user interest based on the number of users who make a trip request within a specified vicinity and time period. An option selection module selects geographic regions and providers for inclusion in a list of service options presented to the user based on global optimization across geographic regions within a threshold distance of the user's origin location. A trip price estimation module calculates estimated values for each of the service options and sends the estimated values to the option selection module for display on the computing device. Data regarding service options presented to and selected by users is input to an optimization engine, which predicts user demand across geographic regions and time periods and positions providers based on predicted demand.

### TECHNICAL FIELD

The subject matter described herein generally relates to the field of network systems, and, more particularly, to optimizing resource allocation among different regions.

### BACKGROUND

Network systems, such as transport management systems, provide support for the logistical issues in managing the transportation of persons, cargo, or the like. In some systems, a provider provides transportation services to a user to a location selected by the user in exchange for a fee. In typical systems, a user checking a price or requesting service is matched with one of a plurality of available providers. Typically, the provider with whom the user is matched is the provider who has the shortest estimated time of arrival to the origin location. This may lead to inefficient allocation of resources, particularly in instances where there is high user demand concentrated in a geographic region (“geo”). For example, vehicles located in geos of low demand may be sitting idle, polluting the air and crowding the street instead of providing service in nearby regions with lower provider supply and higher user demand.

### SUMMARY

To enable a more efficient allocation of resources among different geos and a higher rate of user conversion, a network system uses global optimization across geos to calculate and provide multiple service options to users that may want to request services (e.g., transport or delivery services, also referred to as a trip) through a user application. In one embodiment, the network system provides multiple service options each time that a user transmits a set of service data indicating an interest in potentially requesting service facilitated by the network system. In other embodiments, the network system provides multiple service options responsive to predicting a period of high user demand within a specified vicinity or geography and during a time period.

According to an example, a trip management module receives, through a user application, user input including a set of service data. In one embodiment, the service data includes at least an origin location, a destination location, a desired departure time, and/or a request for an estimated value. In response to receiving the service data, an option selection module selects geos within a threshold distance of the origin location or the origin geo of the user for inclusion in a set of service options that can be presented to the user via the user application. In some embodiments, the option selection module determines the threshold distance based in part on the desired departure time. For example, if the desired departure time is in 30 minutes, the option selection module might include geos 1, 2, and 3, but if the desired departure time is in 35 minutes, the option selection might also include geo 4 when determining the set of service options to be presented to the user. The option selection module then queries a geo data store for pricing information (e.g., price multiplier data) for the selected geos and sends the received data to an option selection module for selection of the service options.

Still further, in one example, an option selection module selects service options to present through the user application to optimize the matching of users and providers across geos. In one embodiment, the option selection module receives as input a number of market status factors in selecting the service options, including the origin and destination locations, the desired departure time, the current user demand for service, predictions of future demand, number and location of available providers, and/or pricing information in geos within a threshold distance of the origin location or the origin geo of the user. Additionally, the market status factors may include, for each of the available providers located within a threshold distance of the origin location or the origin geo of the user, the distance and estimated time from the provider's current location to the origin location.

After selecting service options to present to the user, the option selection module queries a trip price estimation module to obtain trip estimate values (e.g., estimated prices or costs). The trip price estimation module calculates or computes an estimated value (e.g., estimated trip cost) for each of the selected service options and sends the estimate values to the option selection module for display on the user client device. The estimated value can be based on an estimated distance to be traveled along a predicted or proposed route(s), and/or estimated duration of time of travel. In some embodiments, the service options and associated estimates are pushed to the user client device if the user subscribes to a real-time information push. In other embodiments, the service options and associated estimates are displayed on the user client device responsive to the user checking prices or requesting a service through the user application.

In response to a user selecting a service option via the user application, the user application can generate data corresponding to a request for a service through the network system (e.g., also referred to herein as a “trip request”). In some embodiments, the network system uses information from the trip request to match the user with one of a plurality of available drivers based on the market status factors.

The network system also uses the information from trip requests to predict future demand across geos and time periods and to position providers based on predicted demand. In some embodiments, a demand prediction module generates and trains an optimization model to predict user demand over upcoming time periods using stored data including historical trip data and data regarding service options presented to and selected by users. The trained optimization model is used to position providers across and within geos to optimize the number of trip requests that the network system is able to fulfill and improve the performance of the network system by reducing inefficiencies and providing additional benefits such as a reduction in pollution and wasted energy

### BRIEF DESCRIPTION OF THE DRAWINGS

FIG. 1 illustrates the system environment for an example network system, in accordance with an embodiment.

FIG. 2 is an interaction diagram for optimizing resource allocation based on demand prediction, in accordance with an embodiment.

FIG. 3 illustrates an example map depicting price multipliers and available providers in different geos, in accordance with an embodiment.

FIG. 4 illustrates an example map depicting a service that is assigned to a provider and in which the provider is traveling from the provider's current location to an origin location, in accordance with an embodiment.

FIG. 5 is an example user interface on a user client application for displaying alternative service options, in accordance with an embodiment.

FIG. 6 is an example user interface on a provider client application for displaying alternative service options, in accordance with an embodiment.

FIG. 7 illustrates example components of a computer used as part or all of the network system, the user client device, and/or the provider client device, in accordance with an embodiment.

FIG. 8 is a flow chart illustrating the selection of alternative service options based on market status factors, in accordance with an embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

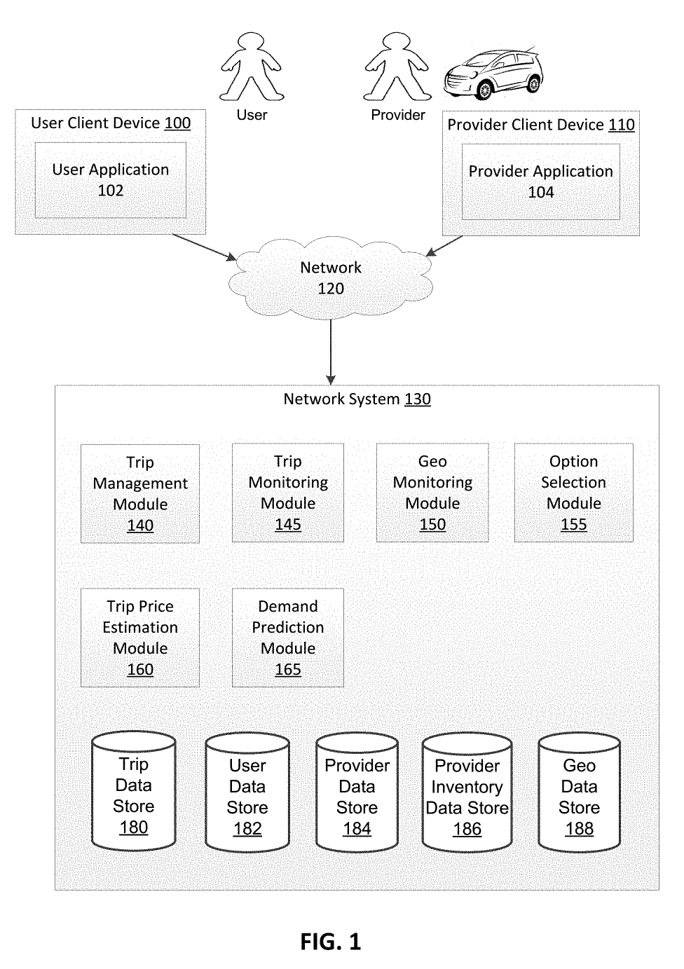

Turning now to the specifics of the system architecture, FIG. 1 illustrates a system environment for an example network system 130. The network system 130 coordinates the transportation of persons and/or goods/items for a user (e.g., such as a rider) by a service provider (e.g., a provider of a vehicle). The provider uses a vehicle to provide the transportation to the user. In this example embodiment, the network system 130 includes a trip management module 140, a trip monitoring module 145, a geo monitoring module 150, an option selection module 155, a trip price estimation module 160, a demand prediction module 165, and various data stores including a trip data store 180, a user data store 182, a provider data store 184, a provider inventory data store 186, and a geo data store 188. These modules and data stores are not native components of a generic computer system, and provide structures and functions beyond generic functions of a computer system, as further described below.

A user operates a client device 100 that executes a user application 102 that communicates with the network system 130. The user operates the user application 102 to view information about the network system 130, and to make a request for service from the network system 130 for a delivery or transport service (“a trip”) of the user (and, optionally, additional persons) and/or items, for example cargo needing transport. The user application 102 determines an origin location or enables the user to specify an origin location and/or a destination location associated with the trip. An origin location and/or a destination location may be a location inputted by the user or may correspond to the current location of the user client device 100 as determined automatically by a location determination module (not shown) in the user client device 100, e.g., a global positioning system (GPS) component, a wireless networking system, or a combination thereof. For purposes of simplicity, as described herein, an origin location can correspond to a start location for service (i) determined by the user application 102 (e.g., based on the current location of the user client device 100 using a GPS component), (ii) specified or selected by the user, or (iii) determined by the network system 130.

According to examples herein, the user client device 100 can transmit a set of data (e.g., referred to herein as “service data”) to the network system 130 over the network(s) 120 in response to user input or operation of the user application 102. Such service data can be indicative of the user's interest in potentially requesting service (e.g., before actually confirming or requesting the service). For example, the user may launch the user application 102 and specify an origin location and/or a destination location to view information about the network service before making a decision on whether to request service. In some embodiments, the user operates the user application 102 in a default mode in which the user application 102 presents a single service option in response to receiving the service data. In other embodiments, the user application 102 provides a feature to enable the user to operate the user application 102 in an option-spectrum feature mode in which the user application 102 presents various service options in response to receiving service data from the user.

The user may want to view information about the average or estimated time of arrival for pick up by a provider, the estimated time to the destination, the price, the available service types, etc. Depending on implementation, the service data can include the origin and/or destination location information, user information (e.g., identifier), application information (e.g., version number), device identifier or type, etc. According to some examples, each time the user modifies the origin and/or destination location, the user application 102 can generate and transmit the service data to the network system 130. Still further, in one example, the service data can include data used by the demand prediction module 165 to predict user demand in geos. In some embodiments, the service data comprises a request for an estimated cost or price for the service and includes at least the origin location and the destination location specified by the user. Additionally, in one example, in response to transmitting the service data, the user application 102 can receive a set of service options from the network system 130 to be displayed on the user client device 100.

Once the user confirms or orders a service via the user application 102, the user application 102 can generate data corresponding to a request for the service through the network system 130 (e.g., also referred to herein as a “trip request”). In some embodiments, the network system 130 uses information from the trip request to match the user with one of a plurality of available providers. Depending on implementation, the trip request can include user or device information (e.g., a user identifier, a device identifier), a service type (e.g., vehicle type) and/or selected service option (such as described herein), an origin location, a destination location, a payment profile identifier, and/or other data. The network system 130 selects a provider from a set of providers, such as based on the provider's current location and status (e.g., offline, online, available, etc.) and/or information from the trip request (e.g., service type, origin location, and/or destination location), to provide the service for the user and transport the user from the origin location to the destination location. In other embodiments, the network system 130 provides multiple service options to the user. The user application 102 further enables a user to provide a performance rating for a provider upon completion of a trip. In one embodiment, the rating is provided on a scale of one to five, five being the maximal (best) rating. In an alternative embodiment, the rating is a thumbs up or thumbs down rating indicating either a positive or negative experience.

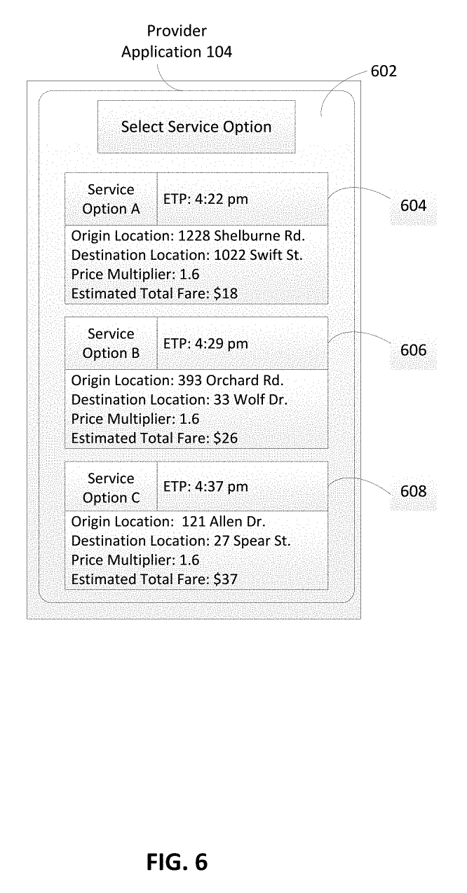

The provider operates a client device 110 executing a provider application 104 that communicates with the network system 130 to provide information indicating whether the provider is available or unavailable to provide transportation services to users. The provider application 104 can also present information about the network service to the provider, such as invitations to provide service, navigation instructions, map data, etc. In one embodiment, the provider application 104 enables the provider to provide information regarding availability of the provider by logging into the network system 130 and activating a setting indicating that they are currently available to provide service. The provider application 104 also provides the current location of the provider or the provider client device 110 to the network system 130. Depending on implementation, the current location may be a location inputted by the provider or may correspond to the current location of the provider client device 110 as determined automatically by a location determination module (not shown) in the provider client device 110, e.g., a GPS component, a wireless networking system, or a combination thereof. The provider application 104 further allows a provider to receive, from the trip management module 140, an invitation message to provide a service for a requesting user, and if the provider accepts via input, the provider application 104 can transmit an acceptance message to the trip management module 140. The trip management module 140 can subsequently provide information about the provider to the user application 102. As another embodiment, the provider application 104 can enable the provider to view a spectrum of service options corresponding to received trip requests and to select particular trip request(s) to fulfill. The trip management module 140 selects service options for display to the provider based on predicted demand over a specified time period within a threshold distance of the provider's current location or geo, as discussed below with respect to FIG. 6.

In some embodiments, the service options presented through the provider application 104 include a guaranteed price multiplier (and thus a higher total trip price) if the provider accepts and fulfills a trip request during an upcoming period of predicted high demand. For example, a service option might include a guaranteed 1.8 price multiplier if the provider accepts and fulfills a trip request from geo 1 between 5:00 and 6:00 pm on a particular Saturday. In some embodiments, the provider incurs a financial penalty if the provider accepts a service, but does not fulfill the corresponding trip request (e.g., subsequently cancels). Additionally or alternatively, the pricing of a provider service option might change over time as the desired departure time approaches. For example, the demand prediction module 165 might predict on Thursday morning a period of high user demand the following evening between 7:00 and 8:00 pm. A provider who commits on Thursday to accepting and fulfilling trip requests during this time period might receive a higher guaranteed price multiplier than a provider who commits on Friday afternoon.

The provider application 104 can also receive routing information from the trip management module 140. The provider application 104 enables a provider to provide a rating for a user upon completion of a trip. In one embodiment, the rating is provided on a scale of one to five, five being the maximal (best) rating.

The user client device 100 and provider client device 110 are portable electronic devices such as smartphones, tablet devices, wearable computing devices (e.g., smartwatches) or similar devices. Alternatively, the provider client device 110 can correspond to an on-board computing system of a vehicle. Client devices typically have one or more processors, memory, touch screen displays, wireless networking system (e.g., IEEE 802.11), cellular telephony support (e.g., LTE/GSM/UMTS/CDMA/HSDPA, etc.), and location determination capabilities.

The user client device 100 and the provider client device 110 interact with the network system 130 through client applications configured to interact with the network system 130. The applications 102 and 104 of the user client device 100 and the provider client device 110, respectively, can present information received from the network system 130 on a user interface, such as a map of the geo, and the current location of the user client device 100 or the provider client device 110. The applications 102 and 104 running on the user client device 100 and the provider client device 110 can determine the current location of the device and provide the current location to the network system 130.

In one embodiment, the trip management module 140 can be configured as a communicative interface between the user application 102, the provider application 104, and/or the various modules and data stores in the network system 130, and is one means for performing this function. The trip management module 140 can receive provider availability status information and current location information from the provider application 104 and update the provider inventory data store 186 with the availability status. The trip management module 140 can also receive trip requests from the user application 102 and creates corresponding trip records in the trip data store 180. According to an example, a trip record corresponding to a trip request can include or be associated with a trip ID, a user ID, an origin location, a destination location, a service type, pricing information, and/or a status indicating that the corresponding trip request has not been processed. According to one example, when a provider accepts the invitation message to service the trip request for the user, the trip record can be updated with the provider's information as well as the provider's location and the time when the trip request was accepted. Similarly, location and time information about the service as well as the cost for the service can be associated with the trip record.

The trip management module 140 can also send an invitation message to an available provider via the provider client device 110 responsive to receiving user input comprising selection of a service option, and receives a response to the invitation message from the provider through the provider application 104. In one example, the trip management module 140 can also send information to the provider client device 110 at a particular time based on estimated travel times computed by the option selection module 155.

In one embodiment, during the trip, the trip monitoring module 145 receives information (e.g., periodically) from the provider application 104 indicating the location of the provider's vehicle and/or telematics information (e.g., indications of current speed, acceleration/deceleration, events, stops, and so forth). The trip monitoring module 145 stores the information in the trip data store 180 and can associate the information with the trip record.

The geo monitoring module 150 determines price multipliers in specified geos as determined by the network system 130, and sends the price multiplier data to the geo data store 188 for storage. Depending on implementation, a geo can be one of many geos that can be user-defined regions, overlapping regions, regions of different sizes or dimensions, and/or regions defined by a coordinate system or array of shapes (e.g., squares, hexagons, etc.). In one example, a geo can be a smaller geo or sub-geo of a larger geo. Each geo can have an identifier, be defined by a set of location data points or coordinates, and/or be associated with additional geos (e.g., with nearby geos or overlapping geos, etc.). In various embodiments, a price multiplier is a scaling modifier based on resource supply and user demand that is applied to an initial or default trip price to determine a final trip price. For example, the geo monitoring module 150 determines a price multiplier for a geo by querying the trip data store 180 for the number of trips requested with an origin location in the geo and by querying the provider inventory data store 186 for the number of available providers located in a geo (e.g., based on location and provider state). As an addition or an alternative, in another example, the geo monitoring module 150 can determine the price multiplier for a geo based on the number of users that are operating the user application 102 but have not yet requested service in the geo. The geo monitoring module 150 can update the price multiplier for a geo periodically (e.g., perform the computation every three minutes or five minutes, etc.) or based on a schedule.

According to an example, the geo monitoring module 150 computes the price multiplier for a geo based, at least in part, on the number of requested trips that originated in the geo, the number of users operating the client application 102 in the geo, and/or the number of available providers located in the geo. In one example, the geo monitoring module 150 can determine a ratio of requested trips and available providers, and if the ratio of requested trips to available providers is over a threshold, the geo monitoring module 150 computes a price multiplier based on the ratio and applies it to the geo. In some embodiments, the geo monitoring module 150 applies progressively higher price multipliers as the ratio of trip requests to available providers increases.

In response to receiving user input comprising a request for information from the network system 130, the trip management module 140 sends an instruction to an option selection module 155 to select geos and available providers for inclusion as service options to present to the user. In various embodiments, for each set of received service data, the option selection module 155 selects multiple geos for inclusion as service options, such that each geo serves and is served by multiple other geos.

The option selection module 155 selects service options based on global optimization across geos within a threshold distance of the origin location or the origin geo of the user. In some embodiments, the option selection module 155 determines the threshold distance based on the desired departure time. For example, if the desired departure time is in 30 minutes, the option selection module 155 might include geos 1, 2, and 3, but if the desired departure time is in 35 minutes, the option selection module 155 might also include geo 4 when determining the set of service options to be presented to the user.

The option selection module 155 uses a number of market status factors in selecting service options, including the origin and destination locations, the desired departure time, the current demand for user service, predictions of future demand calculated by the demand prediction module 165, the number and location of available providers, and/or pricing information in geos within a threshold distance of the origin location or the origin geo of the user. In some embodiments, the market status factors also include, for each of the available providers located with a threshold distance of the origin location or the origin geo of the user, the distance and estimated time from the provider's current location to the origin location.

To select the service options to present to the user, the option selection module 155 uses the market status factors to select geos and available providers. For example, the option selection module 155 queries the geo data store 188 for price multipliers in geos within a threshold distance of the origin location or the origin geo of the user. The option selection module 155 also queries the provider inventory data store 186 for available providers in these nearby geos, including the locations of the available providers in the geos. For each selected geo, the option selection module 155 calculates the average distance and/or estimated time from the current locations of available providers to the origin location. In some embodiments, the option selection module 155 also queries the demand prediction module 165 for the predicted user demand in the selected geos within a threshold amount of time of the desired departure time.

In some embodiments, the option selection module 155 also queries the trip data store 180 for trip data associated with trip requests made by other users of the network system 130 within a threshold amount of time of the user's trip request. Additionally or alternatively, the option selection module 155 queries the trip data store 180 for trip data associated with trip requests with origin locations within a threshold distance of the origin location or the origin geo of the user. In some embodiments, the trip data includes the origin locations, destination locations, route information, desired departure times, and/or user-provider matching information associated with the trip requests.

According to an example, after receiving the requested data from the geo data store 188, the provider inventory data store 186, the demand prediction module 165, and the trip data store 180, the option selection module 155 selects geos and service options to present to the user. In one embodiment, the option selection module 155 selects all nearby geos. In another embodiment, the option selection module 155 selects the geo of the origin location and all adjacent geos. In still other embodiments, the option selection module 155 selects geos with varying price modifiers. For example, the option selection module 155 might select geos with price multipliers of 1.0×, 2.5×, and 3.0×, respectively. In the various embodiments, the option selection module 155 considers the current (or alternatively, the forecasted) ratio of supply and demand and the applicable price modifiers in nearby geos when selecting geos for inclusion in the set of service options. For example, if the option selection module 155 determines that there is high demand for service relative to the number of available providers in geo 3 and that the ratio is lower in other nearby geos, the option selection module 155 might include fewer or no service options from geo 3 in response to receiving a set of service data with an origin location in geo 1.

In one embodiment, for each of the selected geos, the option selection module 155 selects candidate providers for inclusion as service options. In some embodiments, the candidate provider is a representation of available providers located within a threshold distance of each other in a selected geo. For example, if provider A, provider B, and provider C are all available to provide service and are located within two blocks of each other in geo 1, the option selection module 155 treats the three providers as a single “candidate provider” for purposes of selecting service options to present to the user.

In some embodiments, the option selection module 155 selects the candidate provider with the shortest estimated time of pickup (ETP) at the origin location responsive to a user requesting a desired departure time of “now.” For example, assume that the option selection module 155 selects geo 3 for inclusion in the spectrum of service options presented to a user located in geo 1. If the provider inventory data store reports that candidate provider 1 (representing providers A, B, and C) is approximately 4 minutes away from the origin location, candidate provider 2 (representing providers D, E, F, G, and H) is approximately 7 minutes away from the origin location, and candidate provider 3 (representing providers I and J) is approximately 10 minutes away from the origin location, the option selection module 155 will select candidate provider A for inclusion as a service option. In some embodiments, the option selection module 155 will also include provider B and/or provider C as service options if the option selection module 155 determines that there is limited provider availability in the other selected geos.

Similarly, if the option selection module 155 determines that the ETP at the origin location is the same for providers in different geos, the option selection module 155 will select for inclusion the candidate provider located in the geo with the lowest price multiplier. For example, assume that candidate provider A (located in geo 2), candidate provider B (located in geo 4), and candidate provider C (located in geo 5) are all 15 minutes away from the user. If geo 5 has the lowest price multiplier of the three geos, the option selection module 155 will select candidate provider C for inclusion as a service option.

The option selection module 155 determines a cut-off point for including candidate providers as service options based on the price multiplier in the provider's geo and the ETP at the nearby origin location. In one embodiment, the option selection module 155 selects a ceiling such that when the ETP at the nearby origin location is a specific multiplier of the ETP in the user's geo, the option selection module 155 stops searching for additional candidate providers to include in the service options presented to the user. In other embodiments, the option selection module 155 stops searching for additional candidate providers once the estimated trip price begins to increase after reaching its lowest point.

In one embodiment, the following example illustrates how provider selection can be globally optimized. Let R_{i,j;t} be the trip flow (volume) from geo i to geo j (which is estimated based on selection of service options and usual on-demand request volume) at time t∈T. Let C_{j;t} be the open cars (which is estimated based on the trip flow into a geo and usual driver login schedule) in geo i at time t∈T. Let L_{k;t} be the usual net open cars coming into the marketplace in geo k at time t∈T. Let D_{k,i;t} be the provider selection decision for providers in geo k to fulfill trip requests from geo i at time t∈T. Let τ_{i,j;t} be the travel time from geo i to geo j at time t∈T. Finally, let f (k, i, j;t) be the price (or fare) for a trip from geo i to geo j fulfilled by providers from geo k at time t∈T. The global provider selection optimization problem can be formulated as followss:

$$Maximize \text{:} α {\sum }_{k , i , j , t} f ( k , i , j ; t ) + β MGV$$

$$Such that {\sum }_{j} {R}_{i , j ; t + τ ( k , i , t )} = {\sum }_{k} {D}_{k , i ; t} ∀ i , ∀ t ∈ T$$

$${\sum }_{i} {D}_{k , i ; t} \leq {C}_{k ; t} k , ∀ t ∈ T$$

$${C}_{k ; t} = {\sum }_{i} {\sum }_{s < t - τ ( i , k ; t )} {R}_{i , k ; s} - {\sum }_{j} {\sum }_{s < t} {D}_{k , j ; s} + {\sum }_{s < t} {L}_{k ; s} ∀ k , ∀ t ∈ T$$

where T is a time range in which the provider selection decisions are optimized, MGV is some definition of overall market-generated value, measuring the total values for the users, the providers, and the marketplace generated by responding to the given demand.

Thus, in this example, the option selection module 155 adds the sum (over geos k, j and times t) of the prices of trips going from geo i to geo j fulfilled by provider(s) in geo k at time t times a constant \alpha and the market-generated value times a constant \beta, such that the sum of the trip flow between geos i and j in time section t after the travel time between geos k and i equals the sum (over geos k) of the provider selection decisions on providers in geo k to fulfill trips from geo i for all of geo i and for all times, and such that the sum of the provider selection decisions on providers in geo k to fulfill trips from some geo i is less than or equal to the open cars in geo k for all of geo k and for all times, and such that the open cars in geo k equals the number of trips ending in geo k at time t minus the number of cars selected away from geo k plus the number of open cars moving or logging into geo k for all geo k and for all time t.

After the option selection module 155 selects the service options to present to the user, the option selection module 155 queries the trip price estimation module 160 for estimated trip price for each of the selected service options.

The trip price estimation module 160 estimates the price for a trip requested in a trip request. The trip price estimate represents an estimate of the trip price if a user was assigned to a provider at the point in time when the estimate was generated or at some future point in time. A trip price estimate may be a single determined price or a range within which the trip price might be. In some embodiments, the trip price estimation module 160 determines the probability that the actual trip price will be less than or equal to the trip price estimate, or that the actual trip price will fall within a determined price range of the trip price estimate. The trip price estimation module 160 can also generate an estimate of the minimum trip price for a specified timeframe, and can estimate when that minimum trip price might occur.

The trip price estimation module 160 uses models of the trip price to generate a trip price estimate within a geo. The trip price models can be based on underlying factors that can impact the trip price, such as the duration of the trip, the trip distance, the origin location, the destination, an approximate trip departure time, an estimated time of arrival (“ETA”) at the destination, traffic conditions, the number of passengers on the trip, and/or the type of the provider (e.g., the type of vehicle) servicing the trip. The trip price estimation module 160 may also use historical trip price data to generate the trip price estimate. For example, the trip price estimation module 160 may use historical traffic condition data to predict traffic during the trip, and how that traffic impacts the trip price.

The trip price estimation module 160 may also generate the estimated trip price based on the supply of resources and the demand for trips in the geo of the nearby origin location. For example, if many providers are available to provide trips as compared to the number of potential users that may request trips, the estimated trip price may be lower. Similarly, if many users are requesting trips as compared to the number of available providers, the estimated trip price may be higher. In some embodiments, the trip price estimation module 160 applies a price multiplier during periods of peak user demand.

The trip price estimation module 160 uses a price calculation scheme to estimate a trip price for each of the selected service options. In one embodiment, the total estimated trip price comprises a trip price and a pickup price. The trip price includes the duration of the trip from the nearby origin location to the destination, the length of the trip, and the price multiplier in the geo in which the provider is currently located. The pickup price includes the duration and length of the trip from the provider's current location to the nearby origin location and the price multiplier in the provider's geo. In some embodiments, the pickup price is zero if the nearby origin location and provider location are within a small provider selection radius (e.g., 5 minutes).

After the trip price estimation module 160 calculates the estimated trip prices for each of the selected service options, the trip price estimation module 160 returns the estimated trip prices to the option selection module 155, which sends the service options with the associated trip price estimates for display on the user client device 100. In one embodiment, the service options are automatically pushed to the user client device 100 responsive to the user subscribing to a real-time information push. In other embodiments, the service options are display on the user client device 100 responsive to the user providing user input comprising a request for information through the user application 102.

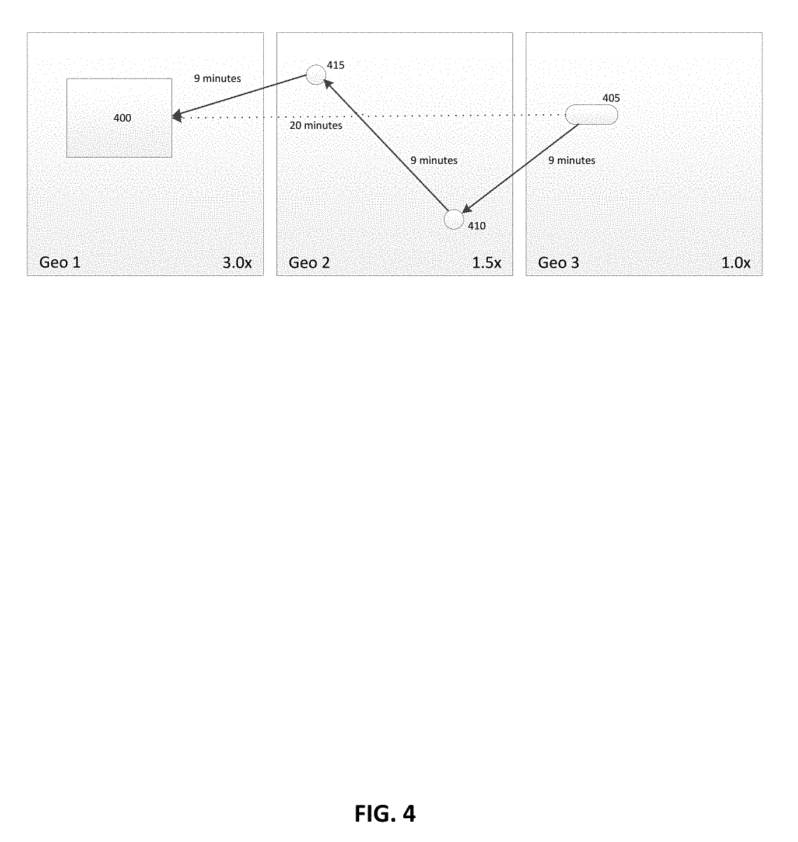

In some embodiments, the service options are associated with single rider transportation services whereby a provider transports a single user from an origin location to a destination location. In other embodiments, the service options correspond to multiple rider transportation services, in which a single provider transports multiple users from origin locations to destination locations. In still other embodiments, the service options include both single rider and multiple rider transportation services based on user input. For example, a user may specify that he or she only wishes to view service options associated with single rider services or that multiple rider services should be presented first in the list of service options. Additionally, in some examples, the service options include transportation services already assigned to providers whereby the provider provides one or more single or multiple rider transportation services to one or more other user while traveling from the provider's current location to the origin location, as described below with respect to FIG. 4.

The option selection module 155 optimizes the order in which the service options are presented to the user through the user application 102. For example, if set of service data associated with a user has a desired departure time of 30 minutes from the current time, the option selection module 155 orders the list of service options such that service options associated with candidate providers who are roughly 30 minutes away from the origin location are presented first. As the current time becomes closer to the desired departure time, the option selection module 155 re-orders the service options such that service options associated with candidate providers who are closer in time to the desired departure time are presented first.

The demand prediction module 165 trains an optimization model to predict user demand over upcoming time periods using stored data including historical trip data and data regarding service options presented to and selected by users. The demand prediction module 165 forms a set of training data that serves as input to generate and train the optimization model. In some embodiments, the training data includes feature vectors of sets of service data from past trips taken by users, including origin locations, destination locations, desired departure times, service options presented to users, and service options selected by users. Additionally or alternatively, the training data includes sets of service data corresponding to requests for transportation services in the future—that is, requests for services where the requestor is not seeking to be picked up at the time the request is being made. In still other embodiments, the training data includes provider availability and location data (e.g., data regarding an available provider's relocation from one geo to another).

In one embodiment, the demand prediction module 165 uses the optimization model to improve predictions of demand over time. After any given time period, the estimated demand for that period is compared to the actual demand (i.e., how may rides were actually requested). The difference between the predicted and actual demand is an error margin that is fed back into the optimization model. If the predicted demand is less than the actual demand, the model is adjusted such that future predictions of demand for similar time periods are larger. Conversely, if the predicted demand exceeded the actual demand, future predictions will be lower. Thus, the optimization model is improved over time to more accurately predict the true demand. The model can also respond dynamically to changes in demand pattern.

In some embodiments, the optimization model is used to optimize trip requests received over a time span (e.g., the next 30 minutes) over a range of geos within a threshold distance of each other. For example, as discussed above with respect to FIG. 1, in response to receiving a set of service data through the user application 102, the option selection module 155 applies the optimization model to determine which geos and candidate providers to include in the set of service options presented to the user.

In response to predicting user demand over time, the optimization model can also be used to predict pricing information. For example, the optimization model might predict pricing in a geo every three minutes for the next 30 minutes or might predict pricing for all geos within a threshold distance every 10 minutes for the next 24 hours.

In still other embodiments, the trip management module 140 uses the output of the optimization model to profile providers and users of the network system 130. For example, the trip management module 140 can use data about service options presented to and selected by users to determine the user's usual schedule and sketch user itineraries and trip patterns. Further, the trip management module 140 can use data regarding service options presented to and selected by providers and provider location data to determine a provider's performance in different geos and provider sensitivity to pricing, distance, and other trip-related properties.

The trip management module 140 uses predictions generated by the optimization model to position providers across and within geos to optimize the number of trip requests that the network system 130 is able to fulfill. In some embodiments, the trip management module 140 sends provider incentives to the provider application 104 to incentivize the provider to travel from the provider's current location to other geos or other regions of the same geo during a predicted period of high demand. The trip management module 140 might display the payment as a standalone incentive or as a component of the provider's income from a specific trip.

The trip data store 180 maintains a record of each in-progress and completed trip coordinated by the network system 130. More specifically, each trip provided by a provider to a user is characterized by a set of attributes (or variables), which together form a trip record that is stored in the trip data store 180. The attributes describe aspects of the provider, the user, and the trip. In one embodiment, each trip record includes a trip identifier (ID), a user ID, a provider ID, the origin location, the destination location, the duration of the trip, the service type for the trip, estimated time of pick up, actual time of pickup, and provider rating by user, user rating by provider, price information, market information, and/or other environmental variables as described below. The variables for the trip record are thus drawn from multiple sources, including the user's master and usage records in the user data store 182, the provider's master and operational records in the provider data store 184, and specific variables captured and received during each trip.

The provider data store 184 stores account and operational information for each provider who participates in the network system 130. For each provider, the provider data store 184 stores one or more database records associated with the provider, including both master data and usage data. In some examples, master data for a provider includes the provider's name, provider's license information, insurance information, vehicle information (year, make, model, vehicle ID, license plate), address information, cell phone number, payment information (e.g., credit card number), sign-up date, provider service type (regular, luxury, van, etc.), device type (e.g., type of cell phone), platform type (e.g., iOS, Android), application ID, and/or application version for the provider application 104.

The provider inventory data store 186 stores provider availability status information received from the trip management module 140, including whether the provider is available for matching and the location of the provider (which gets updated periodically). When the trip management module 140 receives a trip request, the trip management module 140 determines, from the provider inventory data store 186, which providers are potential candidates to pick up the user for the newly created trip. When the network system 130 marks a trip record as complete, the network system 130 can add the provider back into the inventory of available providers in the provider inventory data store 186.

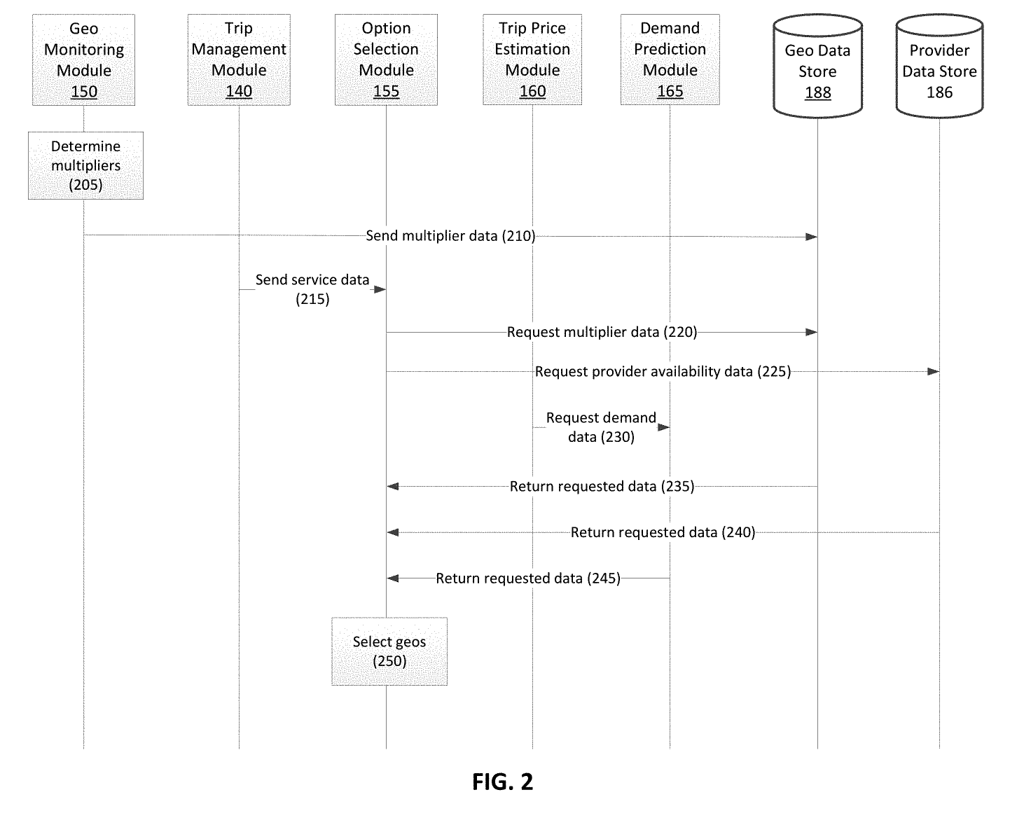

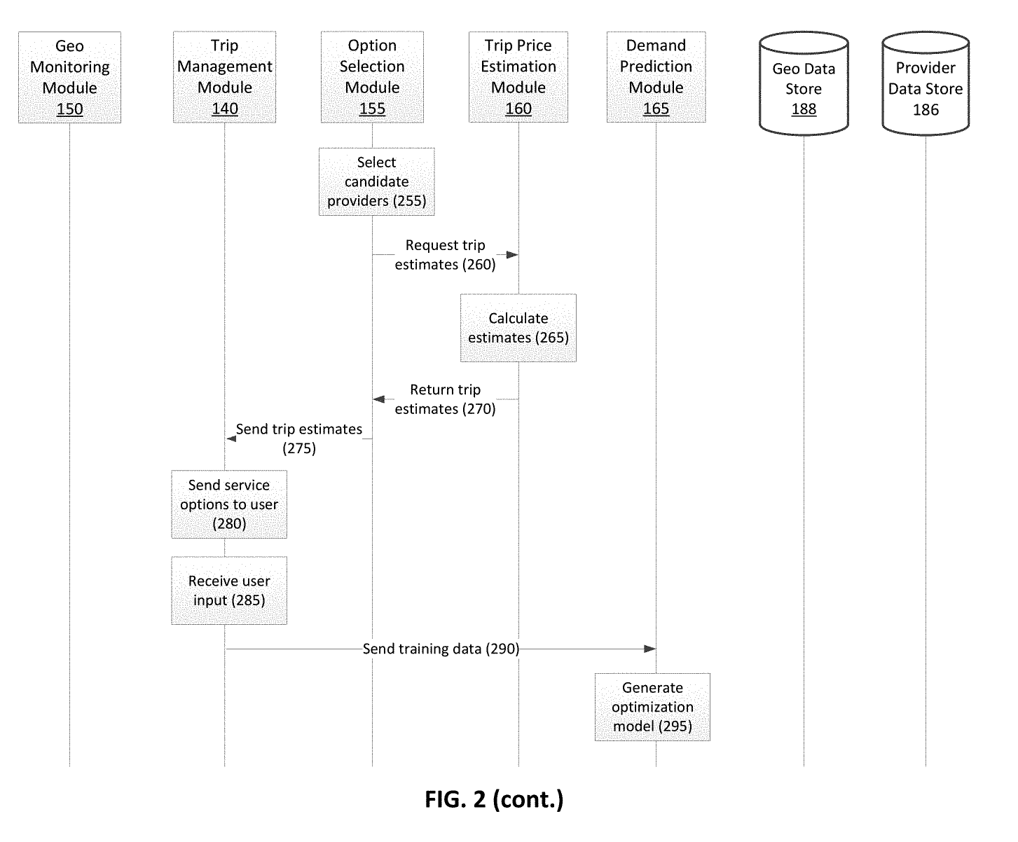

FIG. 2 is an interaction diagram for optimizing resource allocation based on demand prediction, according to an embodiment. At 205, the geo monitoring module 150 determines price multipliers in geos and sends 210 the price multiplier data to the geo data store 188 for storage. In one embodiment, the geo monitoring module 150 determines price multipliers by comparing the ratio of trip requests in a geo with the number of available providers. If the ratio of trip requests to available providers is over a threshold, the geo monitoring module 150 applies a price multiplier to the geo. In some embodiments, the geo monitoring module 150 applies progressively higher price multipliers as the ratio of trip requests to available providers increases.

In response to receiving a set of service data from a user of a user client device 100, the trip management module 140 sends 215 the received service data to the option selection module 155, which selects geos and/or candidate providers for inclusion in a list of service options. At 220, the option selection module 155 queries the geo data store 188 for price multipliers in geos within a threshold distance of the origin location or the origin geo of the user. The option selection module 155 also queries 225 the provider inventory data store 186 for available providers in these nearby geos, including the locations of the available providers in the geos. For each selected geo, the option selection module 155 calculates the average distance and/or estimated time from the current locations of the available providers to the origin location. In some embodiments, the option selection module 155 further queries 230 the demand prediction module 165 for the predicted user demand in the selected geos within a threshold amount of time of the desired departure time.

In some examples, in response to the geo data store 188, the provider inventory data store 186, and the demand prediction module 165 returning 235, 240, and 245 the requested data, the option selection module 155 selects 250 geos for inclusion in the list of service options that will be presented to the user. In some embodiments, the option selection module 155 also uses trip data received from the trip data store 180 to determine the set of service options, as discussed above with respect to FIG. 1. In one embodiment, the option selection module 155 selects all nearby geos. In another embodiment, the option selection module 155 selects the geo in which the nearby origin location is located and all adjacent geos. In still other embodiments, the option selection module 155 selects geos with varying price multipliers. According to various examples, the option selection module 155 considers the current ratio of supply and demand and the applicable price modifiers in nearby geos when selecting geos for inclusion in the set of service options, as discussed above with respect to FIG. 1.

For each of the selected geos, the option selection module 155 selects 255 candidate providers for inclusion as service options. In one embodiment, the option selection module 155 selects the candidate provider for whom the ETP at the nearby origin location is the least. In another embodiment, if the option selection module 155 determines that the ETP at the nearby origin location is the same for candidate providers in different geos, the option selection module 155 selects the candidate provider located in the geo with the lowest price multiplier. In still other embodiments, the option selection module 155 selects candidate providers based on user input regarding desired departure time. In all embodiments, the option selection module 155 determines a cut-off point for including candidate providers as service options based on the price multiplier in the candidate provider's geo and the ETP at the nearby origin location.

After selecting the service options to present to the user, the option selection module 155 queries 260 the trip price estimation module 160 for trip price estimates. At 265, the trip price estimation module 160 calculates an estimated trip price for each of the selected service options. In one embodiment, the estimated trip price comprises a trip price and a pickup price, such as discussed above with respect to FIG. 1. After calculating the estimated trip prices, the trip price estimation module 160 returns 270 the estimates to the option selection module 155, which sends 275 the service options with associated trip price estimates for to the trip management module 140 display 280 on the user client device 100.

The trip management module 140 receives 285 user input comprising selection of one of the presented service options, and sends 290 data regarding the selected service option to the demand prediction module 165. The demand prediction module 165 uses training data including the presented service options, the selected service option, and sets of training data from past trips taken by users (including origin locations, destination locations, desired departure times, service options presented to users, and service options selected by users) to generate 295 an optimization model to predict user demand over upcoming time periods. In some embodiments, the training data includes sets of service data corresponding to requests for transportation services in the future. In other embodiments, the training data includes provider availability and location data (e.g., data regarding an available provider's relocation from one geo to another). The training data serves as input to generate and train the optimization model, as discussed above with respect to FIG. 1. Once trained, the demand prediction module 165 uses the optimization model to improve predictions over user demand and optimize trip requests received over a time span over a range of geos within a threshold distance of each other.

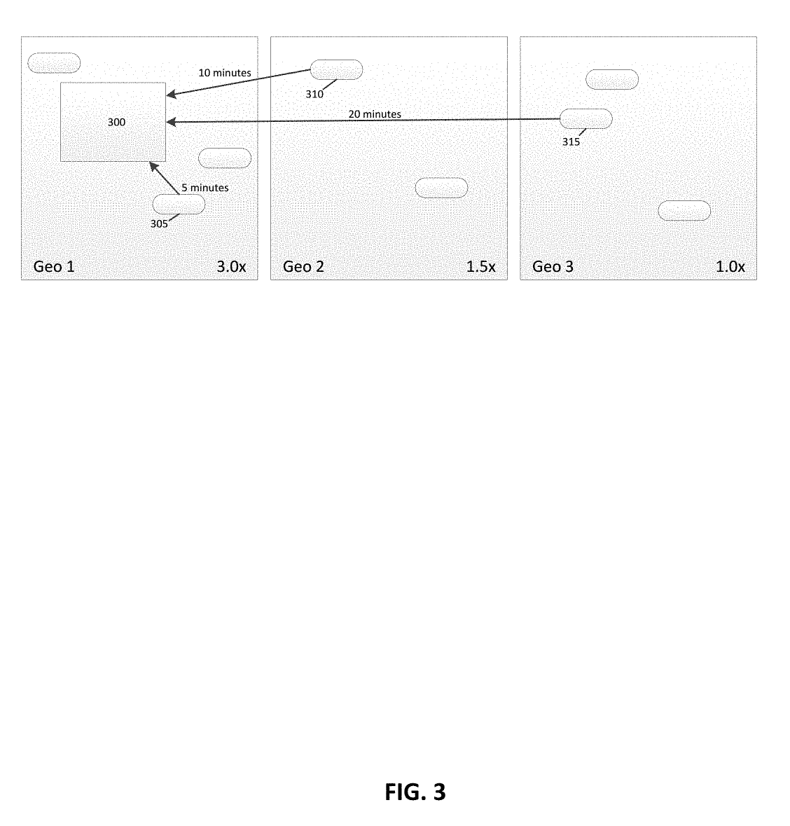

FIG. 3 is a conceptual illustration of an example geo map depicting price multipliers and candidate providers in different geos, in accordance with an embodiment. Assume that a user of a user client device 100 is attending a baseball game at a stadium 300 located in geo 1. Twenty minutes before the end of the game, the user opens the user application 102 to make a trip request. In response to receiving a set of service data including at least an origin location, a destination location, and/or a desired departure time (or default departure time), the option selection module 155 selects a spectrum of available service options to present to the user.

As illustrated in FIG. 3, price multipliers may be different across geos. For example, the price multiplier in geo 1, where the baseball game is taking place, is 3.0×, while the price multipliers in neighboring geos 2 and 3 are 1.5× and 1.0×, respectively, where x is an initial trip price to which the price multiplier is applied to determine a final trip price estimate. The user located at the stadium 300 may be presented with a number of service options 305, 310, and 315 with varying price multipliers and ETPs at the nearby origin location. The estimated trip price associated with each service option will be based on the price multiplier in the geo in which the provider is located. For example, for service option 305, the provider is located five minutes away from the nearby origin location (i.e., the stadium 300), and the price multiplier is 3.0×. For service option 310, the provider is located ten minutes away from the nearby origin location, and the price multiplier is 1.5×. For service option 315, the provider is located 20 minutes away from the nearby origin location, and the price multiplier is 1.0× (i.e., there is no price multiplier in geo 3).

In one embodiment, the option selection module 155 orders the list of available rides from quickest to slowest (i.e., service option 305, service option 310, service option 315). In another embodiment, the option selection module 155 orders the list from least expensive to most expensive based on the trip price estimates calculated by the trip price estimation module 160. For example, if the destination location is a short distance from the nearby origin location, service option 305 might be the least expensive, despite having the highest price. In still other embodiments, depending on the desired departure time, the option selection module 155 orders the list of service options such that providers who are located further away are displayed first. For example, if the desired departure time is approximately twenty minutes, the option selection module 155 will order the list of service options such that service option 315 is presented first.

FIG. 4 is a conceptual illustration of an example geo map depicting an already-assigned trip (e.g., a service that is previously assigned to a user to be provided by a provider, but the user has not yet been picked up), where the provider is traveling from a current location to the origin location, in accordance with an embodiment. Assume that user A is getting ready to leave work for the day and submits a set of service data including a request for a trip from the user's office 400 to the user's home and a desired departure time of 30 minutes from the current time. In response to receiving the set of service data, the option selection module 155 selects a spectrum of available service options to present to user A.

Assume that candidate provider 405, who is located approximately 20 minutes away from the origin location 400 is included as a service option. In one embodiment, in response to user A selecting service option 405, the trip management module 140 sends an invitation message to provide the requested service to a candidate provider associated with service option 405 in 10 minutes (i.e., such that the candidate provider will arrive at the origin location at the desired departure time). In other embodiments, however, in response to user A selecting service option 405, the trip management module 140 schedules one or more already-assigned trips whereby candidate provider 405 provides one or more transportation services to one or more other users while traveling from the current location to the origin location 400.

For example, assume that user A has selected service option 405 from the list of service options in which a candidate provider associated with the service option 405 is assigned to user A. In response to user B submitting a trip request with an origin location and a destination location located between candidate provider 405's current location and the origin location 400 and a desired departure time of “now,” the trip management module 140 schedules an already-assigned trip whereby the candidate provider associated with service option 405 travels to user B's origin location 410 (9 minutes) and transports user B from the origin location 410 to the destination location 415 (9 minutes) before traveling from destination location 415 to origin location 400 to pickup user A (9 minutes).

In some embodiments, the trip management module 140 schedules an already-assigned trip in response to determining that the total estimated time for the already-assigned trip is within a threshold amount of time of user A's desired departure time. In other embodiments, the trip management module 140 schedules an already-assigned trip in response to determining that user B's desired departure time is within a threshold amount of time of user A's desired departure time. For example, if user B's desired departure time is in 20 minutes and the total estimated time for trip B is 27 minutes (bringing the ETP at the origin location 400 to 47 minutes), the trip management module 140 will not schedule the already-assigned trip for user B.

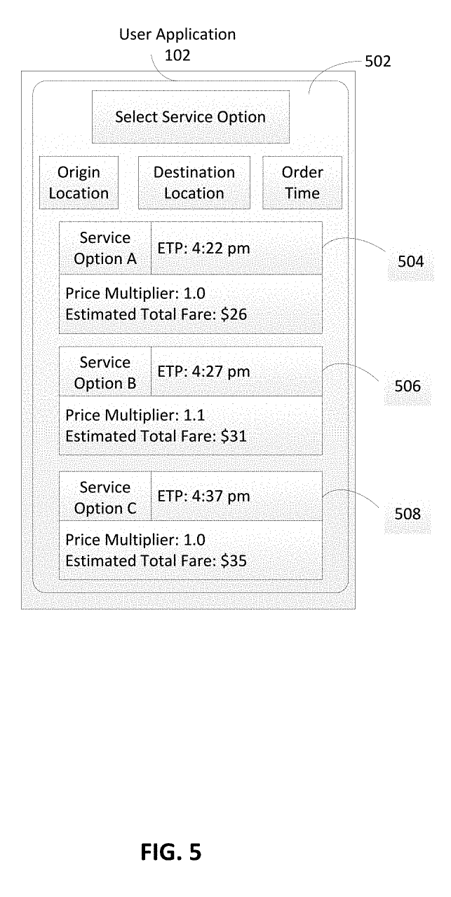

The user application 102 presents the service options to the user and provides the user with the ability to select a service option from the presented service options. FIG. 5 illustrates an example user interface 502 on the user application 102 for displaying alternative service options. In the illustration, the user interface 502 displays the origin location, the destination location, the order time, and the service options 504, 506, and 508. In the illustration, the user interface 502 includes three service options. In other embodiments, more or fewer service options are included. The presentation of each of the service options 504, 506, and 508 includes information about the respective service options, for example, the ETP, the applicable price multiplier, and the estimated trip price. In some embodiments, the information further includes whether the service option is a one-to-one or a one-to-many service option. In some embodiments, the service options include trips with ETPs at the nearby origin location presented in minutes. Alternatively, the service options might include trips with ETPs presented in hours or days.

In embodiments where the order time is hours or days from the time the trip request is made (e.g., earlier than a threshold amount of time before), the demand prediction module 165 uses data from the trip requests to forecast scheduled demand including origin locations, destination locations, and timing. For example, if the number of users requesting rides to the airport in the next week exceeds a threshold, the demand prediction module 165 might infer that the real-time trip requests during the evening commute will be less than usual.

Assume that a user attending a baseball game at a stadium in geo 1 opens the user application 102 at 4:17 pm, roughly twenty minutes before the end of the game, to make a trip request. The user inputs the origin location, the destination location, and an order time of “now.” Responsive to receiving the service data, the option selection module 155 sends for display on the user client device 100 the service options 504, 506, 508. Service option A includes a provider currently located in the same geo as the user and has an ETP at the origin location of 4:22 pm, 5 minutes from the order time. Because the current demand for rides is low, the price multiplier in geo 1 is 1.0×, and the total estimated price to the destination location is $26.

Service option B includes a provider located in neighboring geo 2 arriving at the origin location approximately ten minutes after the order time, at 4:27 pm. The price multiplier in geo 2 is currently 1.1×, and the total estimated price to the destination location is $31. Though service option B is more expensive and has a longer ETP than service option 1, the user might choose service option B if, for example, the score is close, and the user does not want to leave the game immediately.

Service option C includes a provider located in geo 3 arriving at the origin location approximately twenty minutes after the order time, at 4:37 pm (i.e., the time the baseball game is estimated to end). The price multiplier in geo 3 is 1.0×, and the total estimated price to the destination location is $35. Service option C gives the user an option to remain at the game until its estimated end for a relatively low price. By comparison, if the user waited until the end of the game to make a trip request, the price multipliers would likely increase as more spectators leave the stadium.

FIG. 6 illustrates an example user interface on a provider application 104 showing service options for selection by a provider, in accordance with an embodiment. As discussed above with respect to FIG. 1, a provider can select from a number of service options representing various trip requests submitted by users of the network system 130. The trip management module 140 selects trip requests to display as service options to the provider based on predicted demand over a specified time period within a threshold distance of the provider's current location or geo, as determined by the demand prediction module 165.

For example, FIG. 6 displays three service options 604, 606, and 608 presented on user interface 602. In other embodiments, more or fewer service options are displayed depending on the number of trip requests and/or the predicted demand. The presentation of each of service options 604, 606, and 608 includes information about the respective service options, for example, the ETP, the applicable price multiplier, and the estimated trip price. In some embodiments, the information further includes optional already-assigned trips associated with one or more of the service options 604, 606, and 608. In some embodiments, the service options include trips with ETPs at the origin location presented in minutes. Additionally or alternatively, the service options might include trips with ETPs presented in hours or days.

Assume that a provider located in geo 2, where the current surge multiplier is 1.6, opens the provider application 104 at 4:16 pm to select one or more trip requests to fulfill. The provider application 104 displays one or more service options selected based application of the market status factors, including the origin and destination locations and desired departure times input by the users, the current user demand for service, predictions of future demand, number and locations of other available providers, and pricing information in geos within a threshold distance of the origin locations or the origin geos of the users.

Service option A 604 corresponds to a user whose origin and destination locations are in the same geo as the provider's current location. With the applicable price multiplier, the estimated total price for service option A 604 is $18, and the ETP by the provider at the origin location is 4:22 pm. Service option B 606 corresponds to a user whose origin and destination locations are in geo 3. With the applicable price multiplier for geo 2 (the geo in which the provider is currently located), the estimated total fare is $26, and the ETP by the provider is 4:29 pm. In some embodiments, the estimated total price incorporates an incentive for the provider to travel from geo 2 to the origin location in geo 3. Finally, service option C 608 corresponds to a user whose origin location is in geo 3 and whose destination location is in geo 4. With the applicable price multiplier for geo 2, the estimated total price is $37 and the ETP by the provider is 4:37 pm. In each of service options 604, 606, and 608, the applicable price multiplier is the current price multiplier in geo 2, the geo in which the provider is currently located. In some embodiments, one or more of the presented service options might include one or more already-assigned trips. For example, service option C 608 might include an already-assigned trip with an origin location in geo 2, a destination location in geo 3, and an estimated time of arrival at the already-assigned trip destination location before the desired departure time of the first user.

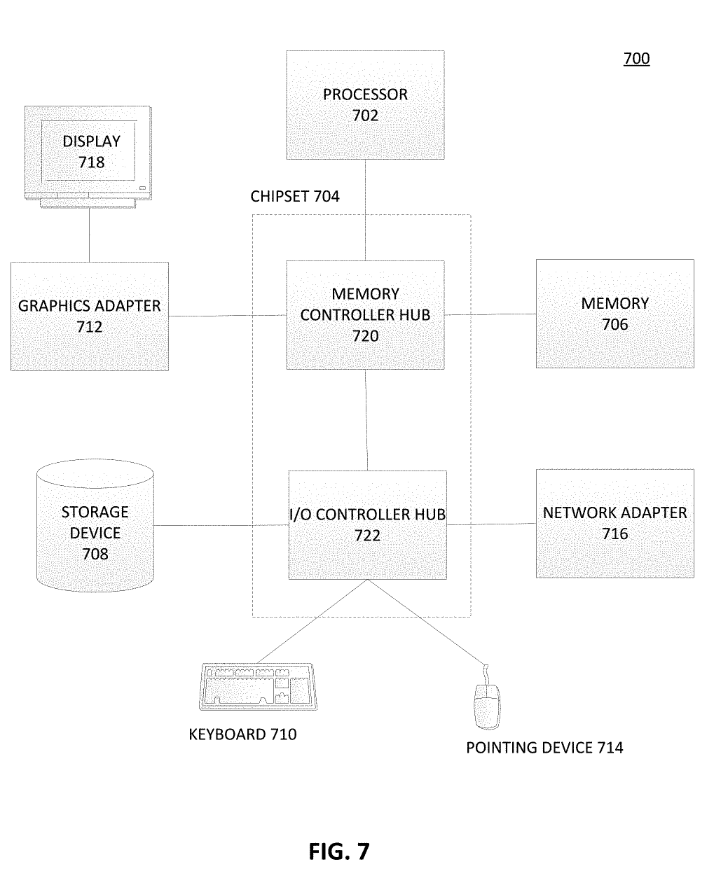

FIG. 7 is a block diagram illustrating physical components of a computer 700 used as part or all of the network system 130, user client device 100, or provider client device 110 from FIG. 1, in accordance with an embodiment. Illustrated are at least one processor 702 coupled to a chipset 704. Also coupled to the chipset 704 are a memory 706, a storage device 708, a graphics adapter 712, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The graphics adapter 712 displays images and other information on the display 718. The network adapter 716 couples the computer 700 to a local or wide area network.

As is known in the art, a computer 700 can have different and/or other components than those shown in FIG. 7. In addition, the computer 700 can lack certain illustrated components. In one embodiment, a computer 700, such as a host or smartphone, may lack a graphics adapter 712, and/or display 718, as well as a keyboard 710 or external pointing device 714. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

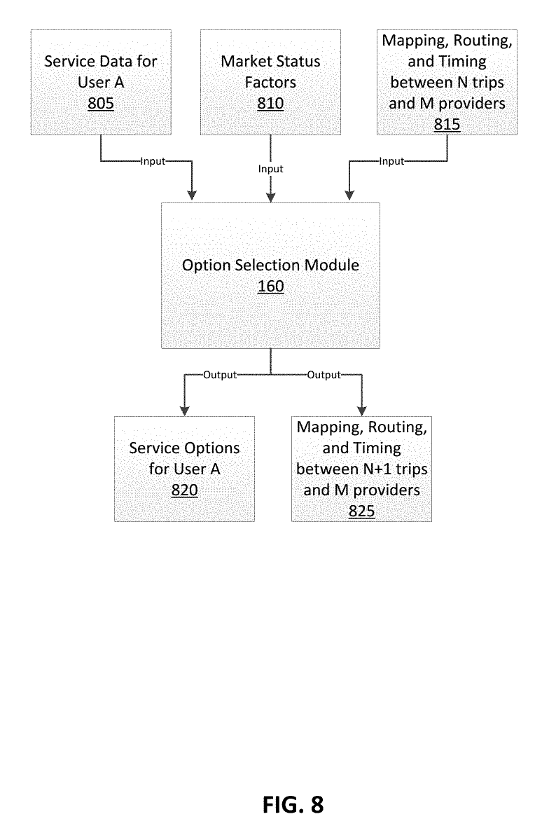

FIG. 8 is a flow chart illustrating the selection of service options based on market status factors, in accordance with an embodiment. The option selection module 155 receives as input a set of service data 805 received from a user A, the set of service data including an origin location, a destination location, and a desired departure time. In some embodiments, the set of service data 805 includes a request for a single rider transportation service. In other embodiments, the set of service data 805 includes a request for a multiple rider transportation service.

The option selection module 155 also receives as input a number of market status factors 810, including the current user demand for service, predictions of future demand in geos within a threshold distance of the origin location or the origin geo of the user, the number and location of available providers, and pricing information in geos within a threshold distance of the origin location or the origin geo of the user. Additionally, the market status factors 810 may include, for each of the available providers located within a threshold distance of the origin location or the origin geo of the user, the distance and estimated time from the provider's current location to the origin location.

In some embodiments, the option selection module 155 queries the trip data store 180 for trip data associated with trip requests made within a threshold period of time of user A's trip request. Additionally or alternatively, the option selection module 155 queries the trip data store 180 for trip data associated with trip requests with origin locations within a threshold distance of the origin location or origin geo of user A. The trip data store 180 returns the requested trip data 815, including the origin locations, destination locations, route information, desired departure times, and user-provider matching information for each of the N trips and M providers associated with the trip requests. In some embodiments, the option selection module 155 uses the trip data 815 as input when selecting the service options for user A.

Responsive to receiving as input the service data for user A 805, the market status factors 810, and the trip data 815, the option selection module 155 selects geos and candidate providers, as discussed above with respect to FIG. 1 and outputs a set of service options for user A through the user application 102. In conjunction with selecting the set of service options for user A, the option selection module 155 recalculates the existing trip data, including the user-provider matching information, to account for user A's trip request. Therefore, in some embodiments, the option selection module 155 also outputs updated trip data 825 including the origin locations, destination locations, route information, desired departure times, and user-provider matching information for each of the N+1 trips and M providers.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations while described functionally computationally or logically are understood to be implemented by computer programs or equivalent electrical circuits microcode or the like. Furthermore it has also proven convenient at times to refer to these arrangements of operations as modules without loss of generality. The described operations and their associated modules may be embodied in software firmware hardware or any combinations thereof.

Any of the steps operations or processes described herein may be performed or implemented with one or more hardware or software modules alone or in combination with other devices. In one embodiment a software module is implemented with a computer program product comprising a computer-readable medium containing computer program code which can be executed by a computer processor for performing any or all of the steps operations or processes described.

Embodiments may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory tangible computer readable storage medium or any type of media suitable for storing electronic instructions which may be coupled to a computer system bus. Furthermore any computing systems referred to in the specification may include a single processor or may be architectures employing multiple processor designs for increased computing capability.

Embodiments may also relate to a product that is produced by a computing process described herein. Such a product may comprise information resulting from a computing process where the information is stored on a non-transitory tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention which is set forth in the following claims.

1. A method for allocating resources for a network system, comprising:
Receiving, over one or more networks, a set of data from a computing device associated with a user of the network system, wherein the set of data includes an origin location that is in a first geographic region, a destination location, and a desired departure time; and
processing the set of data by:
selecting a set of service options, wherein each service option includes a candidate provider located in a geographic region within a threshold distance of the first geographic region;
for each service option, computing an estimated value from the origin location to the destination location based at least in part on the candidate provider's current location; and
transmitting, over the one or more networks, data corresponding to the set of service options and estimated values to the computing device for display on the computing device.

2. The method of claim 1, wherein selecting the set of service options comprises:
inputting one or more of: the set of data or trip data associated with other users of the network system; and
selecting:
geographic regions within a threshold distance of the first geographic region; and
candidate providers for the first geographic region and for each selected geographic region.

3. The method of claim 2, wherein the trip data includes sets of service data associated with other users of the network system.

4. The method of claim 1, further comprising generating an optimization model based on the set of service data, the user input, and training data including service options presented to and selected by other users of the network system.

5. The method of claim 1, wherein the set of data comprises a request for service through the network system.

6. The method of claim 1, wherein the set of data comprises a request for an estimated value through the network system.

7. The method of claim 1, wherein the network system positions providers across and within geographic regions responsive to predicting a period of high demand for service.
